(19) United States
(12) Patent Application Publication
(10) Pub. No.: US 2018/0027753 A1
(43) Pub. Date: Feb. 1, 2018

(54) STRUCTURE FOR SUPPORTING, PROTECTING, AND ACCESSING A PLANT

(71) Applicant: Scott James Major, Falls Church, VA (US)

(72) Inventor: Scott James Major, Falls Church, VA (US)

(21) Appl. No.: 15/618,558

(22) Filed: Jun. 9, 2017

Related U.S. Application Data
(60) Provisional application No. 62/368,225, filed on Jul. 29, 2016.

(51) Int. Cl. A01G 9/12; A01G 13/10

(52) U.S. Cl. CPC A01G 9/12; A01G 13/10

(57) ABSTRACT

One exemplary embodiment can be a plant support system. The plant support system can include a plurality of panels, an end support, and a removable top frame. Generally, the plurality of panels includes a first panel and a second panel, and the first and second panels, in turn, include respective vertical portions and horizontal portions, and at least one panel forms an aperture optionally covered by a door to allow access to a plant. The end support can be coupled to the first panel and to the second panel. Typically, the removable top frame is coupled to the first and second panels.

### CROSS-REFERENCE TO RELATED APPLICATIONS

This application claims the benefit of U.S. Provisional Application No. 62/368,225, filed 29 Jul. 2016. U.S. Provisional Application No. 62/368,225, filed 29 Jul. 2016 is hereby incorporated by reference in its entirety.

### FIELD

Generally, the present disclosure pertains to a plant support system or structure for supporting, protecting, and accessing a plant.

### BACKGROUND

Often, plants, such as tomatoes, are grown commercially and by hobbyists. The plants can be attacked by animals, particularly if the plants bear fruit. The assault can be made by burrowing animals attacking the roots and/or stalk of the plant, or the fruit can be ruined by birds, rabbits, mice, dogs, squirrels, and deer. In hot climates, animals often attack tomato plants for water to quench their thirst and such attacks can ruin the fruit for human consumption. In addition, as the plants grow, they are staked to support their growth. However, merely staking the plants fails to protect them.

A combination of staking and cages can be used to support and protect plants. However, such an arrangement fails to provide access to the plant for pruning or feeding the plant, or picking ripened fruit or vegetables. Cutting wire cages to provide access can weaken its support of the plants and create sharpened edges that may cut the grower's hands and/or arms. Also, as the plants grow, the arrangement is generally modified a great deal or replaced to accommodate the plant growth. As an example, if tomato vines exceed about 30 centimeters of the top of the cage, the fruit may have insufficient support resulting in damage to the vines and/or fruit. Thus, there is a desire to provide a system or structure for growing plants that supports, protects, and allows access while being flexible to accommodate the rapid growth of the plants during, e.g., the summer growing season.

### SUMMARY

One exemplary embodiment can be a plant support system. The plant support system can include a plurality of panels, an end support, and a removable top frame. Generally, the plurality of panels includes a first panel and a second panel, and the first and second panels, in turn, include respective vertical portions and horizontal portions, and at least one panel forms an aperture optionally covered by a door to allow access to a plant. The end support can be coupled to the first panel and to the second panel. Typically, the removable top frame is coupled to the first and second panels.

Another exemplary embodiment may be a structure having sufficient toughness for supporting and protecting a plant. The structure can include a base, a plurality of panels, and a top frame. Usually, the base generally forms a Greek cross forming one or more holes along the edges of respective arms, and forming one or more openings between arms. Often, the plurality of panels forms a first set of panels and includes a first panel and a second panel. Usually, the top frame is coupled to a respective top edge of the first and second panels and the plurality of panels provides sufficient toughness to support the plant and protect the plant from animals.

A further exemplary embodiment can be a structure with sufficient toughness for supporting and protecting plants. The structure may include a means for stopping burrowing animals, a means for supporting and protecting a growing plant, and a means for accessing the growing plant.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts. Additionally, not all elements are numbered in the drawings if an element is substantially the same as another numbered element as to not clutter the drawings with numerals. In such instances, the total number of such substantially identical elements depicted or contained by the part or structure may be indicated in the specification.

FIG. 1 is a side, elevational view of an exemplary plant support system or structure.

FIG. 2 is a top, plan view of the exemplary plant support system or structure.

FIG. 3 is a cross-sectional view along lines 3-3 of FIG. 1 of the exemplary plant support system or structure.

FIG. 4 is a cross-sectional view along lines 4-4 of FIG. 1 of the exemplary plant support system or structure.

FIG. 5 is a top, plan view of an exemplary base of the exemplary plant support system or structure.

FIG. 6 is a perspective view of an exemplary plant support system or structure.

FIG. 7 is a partial perspective, exploded view of the exemplary plant support system or structure.

FIG. 8 is a side, elevational view of an exemplary stake of the exemplary plant support system or structure.

FIG. 9 is a top, plan view of an exemplary strip of a stake.

FIG. 10 is a side, elevational view of an exemplary elongated member.

FIG. 11 is a perspective view of an exemplary end support.

FIG. 12 is a side, elevational view of an exemplary securing member.

FIG. 13 is a side, elevational view of an exemplary tool.

FIG. 14 is a top, plan view of an exemplary dowel.

FIG. 15 is a front, elevational view of another exemplary panel.

FIG. 16 is a front, elevational view of an exemplary pair of end supports.

FIG. 17 is a side, elevational view of the another exemplary panel.

FIG. 18 is a front, elevational view of another exemplary side of the plant support system or structure.

FIG. 19 is a perspective view of still another exemplary plant support system or structure.

FIG. 20 is a perspective view of yet another exemplary plant support system or structure.

### DEFINITIONS

As used herein, the words “comprising”, and any form thereof such as “comprise” and “comprises”; “having”, and any form thereof such as “have” and “has”; “including”, and any form thereof such as “includes” and “include”; and “containing” and any form thereof such as “contains” and “contain” are inclusive or open-ended and do not exclude additional, unrecited elements or method steps.

As used herein, the term “about” or “approximately” is defined as being close to or near as understood by one of ordinary skill in the art, and in some embodiments may be quantified as within 10%, more particularly within 5%, still more particularly within 1%, and is in some cases within 0.5%.

As used herein, the term “a” or “an” when used in conjunction with the term comprising or a form thereof may mean “one”, but is also consistent with the meaning of “one or more”, “at least one”, and “one or more than one”.

As used herein, the term “toughness” can mean having sufficient strength to support one or more limbs of a plant, such as a tomato plant, and resist assault from animals such as deer, dogs, rabbits, and squirrels. Generally, sufficient toughness is equivalent to 14 gauge wire or stronger and resists the claws or teeth of animals, such as deer, dogs, rabbits, and squirrels.

As used herein the term “slat” can mean a narrow, thin strip of wood, metal, and/or plastic having sufficient dimensions and toughness to resist assault from animals such as deer, dogs, rabbits, and squirrels.

As used herein, the term “coupled” can mean two items, directly or indirectly, joined, fastened, associated, supported, connected, attached, or formed integrally together either by chemical or mechanical means, by processes including stamping, molding, or welding. What is more, two items can be coupled by the use of a third component such as a mechanical fastener, e.g., a screw, a nail, a staple, or a rivet; an adhesive; or a solder.

As used herein, the term “perimeter” can mean an outer boundary of a figure or an object.

As used herein, the term “Greek cross” can mean an object having the shape of a cross with all arms of substantially equal length.

As used herein, the term “centimeter” can be abbreviated “cm” and the term “meter” can be abbreviated “m”.

### DETAILED DESCRIPTION

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

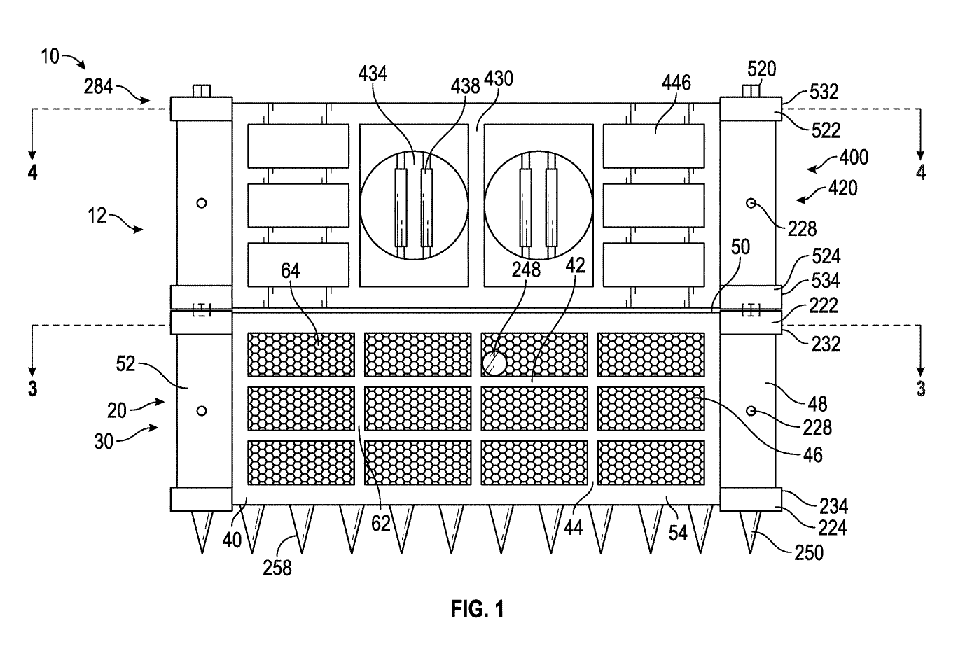

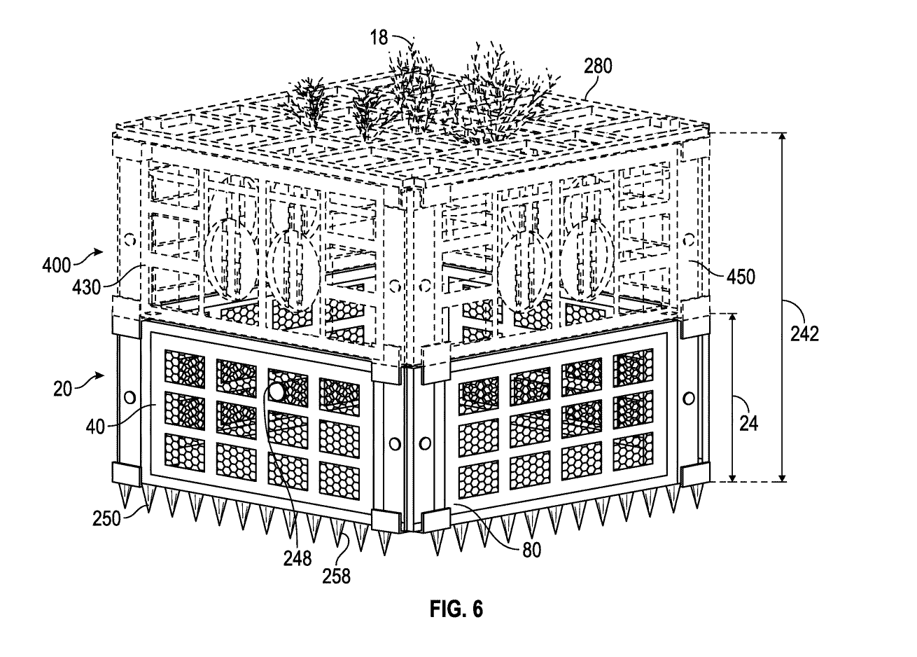

Referring to FIGS. 1-7, an exemplary plant support system or a structure 10 usually has a side or a panel 12 to protect and support a plant 18. The structure 10 can be manufactured from any suitable material, such as plastic, wood, or wire.

The embodiments disclosed herein can protect and support a plant during its growing season. The structure 10 can be raised as the plant 18 grows. Access to the plant 18 can be provided by removable panels or a door formed in the structure 10. The structure 10 can support the plant 18 via the panels 30 without having to utilize a vertical stake. One or more horizontally-orientated rods or dowels 248 can be used to keep vines from falling to the ground, thereby spoiling fruit. The panels 30 are of sufficient toughness to resist efforts of animals such as deer, dogs, rabbits, and squirrels from accessing the interior of the structure 10 and damaging the plant 18 and/or its fruit. Thus, the structures 10 disclosed herein support and protect the plant 18, while permitting access to tend the plant 18 or harvest fruit, vegetables, or flowers. The structure 10 can be used to protect plants such as tomatoes, but can be used for other plants as well.

The structure 10 can include a first set or section 20 of a plurality of panels 30 with sufficient toughness. This set 20 can have a height 24 to surround and protect the plant 18. Generally, the structure 10 includes the plurality, typically six, of panels 30, such as a first panel 40, a second panel 80, a third panel 120, a fourth panel 160, a fifth panel or top frame 280, and a sixth panel or base 300; as well as one or more, typically four, end supports 200; and one or more, typically four, guards or stakes 250. Optionally, the structure 10 can include a second set or section 400 of a plurality, typically four, of panels 420. The second set 400 can be stacked on top of the first set 20 to provide additional height 242 to the structure 10 if, for example, the plant 18 has grown. Thus, the structure 10 can be extended to an elevation 284 at or above the top of the plant 18. End supports 500, preferably substantially the same and in the identical quantity of the end supports 200 of the first set 20, of the second set 400 can be interlocked with corresponding end supports 200 of the first set 20, as hereinafter described. Optionally or alternatively, the top of the plurality of panels 30 can form projections received by grooves formed in the bottom of the plurality of panels 420. The height 242 would generally be the combined height of the first set 20 and second set 400. The height 242 can be at least about 2 meter, and range from about 2-about 3 meter with the base 300 being about 0.25-about 0.70 meter-squared, or even about 0.25-about 0.5 meter-squared.

Although the panels of the sets 20 and 400 are depicted structurally different in FIG. 1, in some exemplary embodiments the sets 20 and 400 can be substantially similar or identical. Usually, the structure 10 can have the appearance of a cube or rectangular cuboid, with the first panel 40 substantially parallel to the third panel 120, the second panel 80 substantially parallel to the fourth panel 160, and the fifth panel 280 substantially parallel to the sixth panel 300.

The first set 20 typically includes four panels, such as a first panel 40. The first panel 40 can be removable from the structure 10, as hereinafter described, to provide access to the plant 18 producing fruit, vegetables, and/or flowers. Because the first panel 40 is substantially similar to the panels 80, 120, and 160 in this exemplary embodiment, only the panel 40 will be discussed in detail. Usually, the first panel 40 is rectangular or square and can include at least one or a plurality of horizontal portions 42 and at least one or plurality of vertical portions 44 forming a grid or a lattice structure 62 surrounding one or more apertures or passages 46. In this exemplary embodiment, twelve apertures 46 are depicted in the first panel 40 allowing air to the plant 18. A wire mesh 64 can be placed behind the first panel 40 to further reduce the size of the apertures 46 and provide an additional barrier to pests. Alternatively, the apertures 46 can be reduced by expanding the number and/or dimensions of the horizontal and vertical portions 42 and 44. In one preferred embodiment, the horizontal and/or vertical portions 42 and 44 can take the form of slats made from any suitable material such as wood or plastic. Such slats can be dimensioned or selected from a material to impart sufficient toughness to the panels 30 and the structure 10 to withstand assault by animals, such as deer, dogs, rabbits, and squirrels. The slats can have a length of about 60-about 92 cm, a width of about 2-about 6 cm, and a thickness of about 0.5-about 2 cm. The portions or slats 42 and 44 can be configured to prevent animals from crawling or flying through the plurality of panels 30, but large enough to allow for the ample passage of light, water, and air to flow the plant 18. The first panel 40 can further include a first edge 48, a second or top edge 50, a third edge 52, and a fourth edge 54.

Referring to FIG. 1, the first panel 430 of the second set 400 can be the same or different from the first panel 40 of the first set 20. The first panel 430 can form two preferably circular or oval apertures 434 adjacent to one another to allow a gardener to insert both arms, preferably at least to the elbow, into the structure 10 to tend the plant 18. One or more spring-loaded spindles 438, in this exemplary embodiment four spring-loaded spindles 438, can be coupled to the first panel 430 to reduce the opening of the apertures 434 to prevent access to the plant by animals, but allow access for the gardener. The first panel 430 can form one or more, or in this exemplary embodiment six apertures 446, to allow light and air to the plant 18.

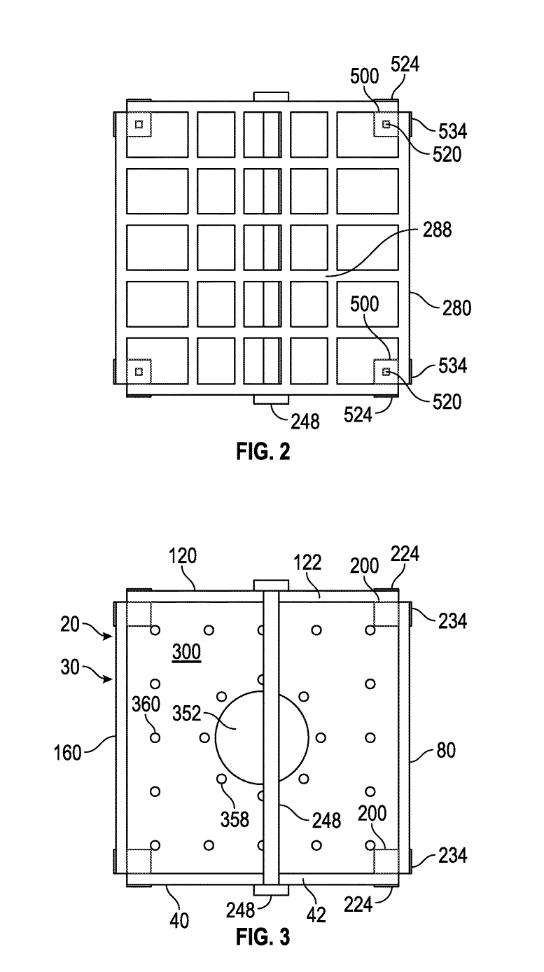

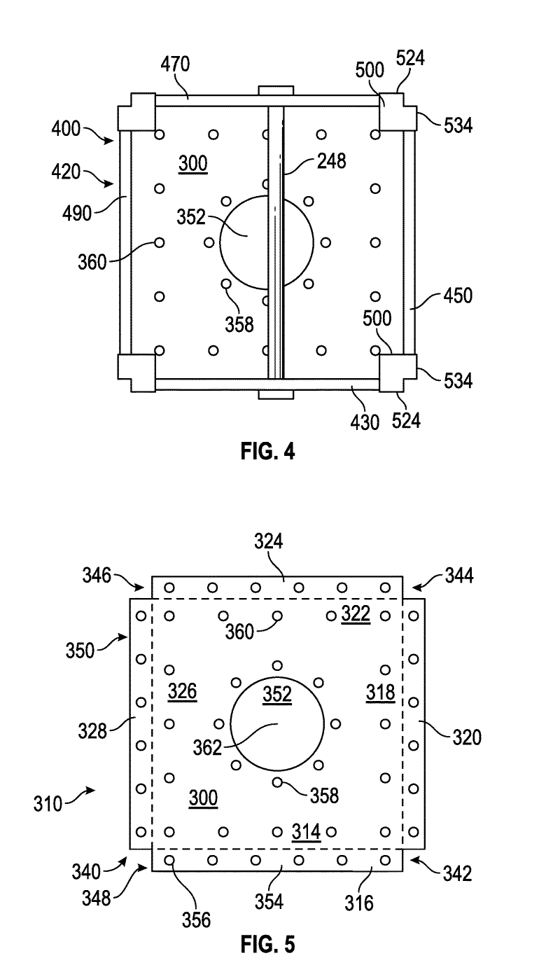

Referring to FIGS. 2 and 4, the top frame 280 can form a grid or a lattice structure 288 of crossed portions or members, similar to the first panel 40. The top frame 280 can be coupled by using hinges or forming one or more extensions on an underside in mated configuration with one or more posts formed on the top edges of the first panel 430, the second panel 450, the third panel 470, and the fourth panel 490 of the second set 400. Alternatively, one or more clips or ties can be used to secure the top frame 280 to rest of the structure 10, and removing the one or more clips or ties can allow access to the plant 18. Generally, the top frame 280 is removable allowing access to the plant 18 for pruning, feeding, and picking fruits, vegetables, and/or flowers.

Referring to FIG. 5, the base 300 can include one or more or at least two arms 310, and in one exemplary embodiment can take the form of a Greek cross, as depicted. In other exemplary embodiments, the base 300 can be of any suitable shape, such as triangular, rectangular, circular, and square. Typically, the base 300 includes one or more arms 310, such as a first arm 314 and a corresponding edge or side 316, a second arm 318 and a corresponding edge or side 320, a third arm 322 and a corresponding edge or side 324, and a fourth arm 326 and a corresponding edge or side 328. Alternatively, the edges can be separate pieces, such as a piece or a strip 354 coupled or formed integrally with the first arm 314. The one or more arms 310 can form one or more openings 340, particularly, the first arm 314 and the second arm 318 can form a right angle at a first opening 342, the second arm 318 and the third arm 322 and can form a right angle at a second opening 344, the third arm 322 and the fourth arm 326 can form a right angle at a third opening 346, and the fourth arm 326 and the first arm 314 can form a right angle at a fourth opening 348. Generally, the base 300 at the one or more openings 340 serves as a pattern for setting the four supports 200 at proper distances for assembling the plurality of panels 30.

The base 300 forms a cutout 352, preferably circular with a center 362, for placement of the plant 18 within the structure 10 and a perimeter 350. The cutout 352 can be any suitable dimension, and is at least about 0.15 m or typically about 0.4-about 0.5 m in diameter. The base 300 can also form one or more, in this exemplary embodiment twenty, although any suitable number may be utilized, perforations 360 for allowing water to pass through the base 300 and provide water to the plant 18. The base 300 can not only protect the plant 18 from burrowing animals, but also suppress the growth of weeds surrounding the plant 18. The base 300 can be manufactured from any suitable material, such as plastic, cloth, and herbicidal-treated paper. The base 300 can ensure proper alignment of the end supports 200.

Referring to FIGS. 5 and 10, the sides 316, 320, 324, and 328 are substantially the same, so only side 316 is described in detail. The side 316 can form one or more, in this exemplary embodiment six although any suitable number may be utilized, holes 356 that can receive one or more elongated members 270 and can have a length of at least about 60 cm, or at least about 61 cm. The elongated members 270 can be made of any suitable material, such as metal, wood, or plastic, and take the form of, independently, spikes, cones, stakes, prongs, screws, and/or nails, and can extend at least about 2 cm, at least about 2.54 cm or even about 2-about 16 cm. The elongated member 270 can have a length or extend to a depth 276 when inserted into the ground. The depth 276 can be sufficient not only to secure the structure 10, but also to impede burrowing animals. The base 300 can also form one or more holes 358, in this exemplary embodiment eight holes although any suitable number of holes may be formed, surrounding the perimeter of the cutout 352. The one or more elongated members 270 can be inserted into respective holes 358 to further prevent burrowing animals from accessing and/or damaging the plant 18.

Referring to FIG. 11, the end support 200 is depicted. The end support 200 has an upper end 212 and a lower end 214, a first side 216 and a second side 218. Generally, four end supports 200, each being substantially identical to each other and the end supports 500, are placed in respective plurality of openings 340 to secure the plurality of panels 30. Typically, the end support 200 forms a protrusion 220 at the upper end 212 and forms a recess 238 at the lower end 214. Moreover, the end support 200 can form a hole 226 that corresponds to a hole 66 in the first panel 40, as hereinafter described. A first bracket 222, a second bracket 224, a third bracket 232, and a fourth bracket 234 can be coupled to the end support 200. The three other end supports can be substantially identical as the end support 200 described above and can receive edges of respective panels 80, 120, and 160, as hereinafter described. Moreover, the panels 40, 80, 120, and 160 are removable without having to use a tool, i.e., using hands only. Referring to FIG. 13, an exemplary tool 162 is depicted, particularly an Allen wrench. One feature of the embodiments disclosed herein is the ability to access the plant without use of a tool, such as an Allen wrench, pliers, or a screwdriver.

Although brackets are depicted fastening the panels together, it should be understood that alternative mechanisms can be used to couple or fasten the plurality of panels 30 together. As an example several hinges can be used to fasten the plurality of panels 30 instead of the end supports. In a further example, the end supports 200 and optionally the base 300 can be omitted and the plurality of panels 30 can be coupled one to the other using any suitable mechanism, such as a combination of tabs and recesses, or projections and grooves.

Referring to FIGS. 1, 8, 9, and 11, a guard or stake 250 can be coupled with at least one of the underneath of the fourth edge 54 of the first panel 40 and the lower end 214 of the end support 200 using any suitable mechanical fasteners. The guard 250 can be used instead or additionally to the elongated members 270 inserted through the sides 316, 320, 324, and 328. The guard 250 can include one or more elongated members 258 coupled or formed integrally with a strip 254. Although any suitable number of elongated members 258 can be utilized, in this exemplary embodiment twelve elongated members 258 are utilized. The elongated members 258 can be, independently, spikes, prongs, cones, stakes, screws, and/or nails. Generally, the guard 250 can have a length 264 and the elongated members 258 can have a depth 266. Typically, there is a space 268 between elongated members 258. The elongated members 258 can have a depth 266 of about 0.01:1-about 0.20:1 of the length 264 of the guard 250 and the space 268 can be about 0.01:1-about 0.05:1 of the length 264 of the guard 250. Generally, the elongated members 258 of the guard 250 are sufficient to secure the structure 10 and prevent animals from burrowing into the structure 10 to the plant 18, and can extend, independently, at least about 2 cm, at least about 2.54 cm or even about 2-about 16 cm.

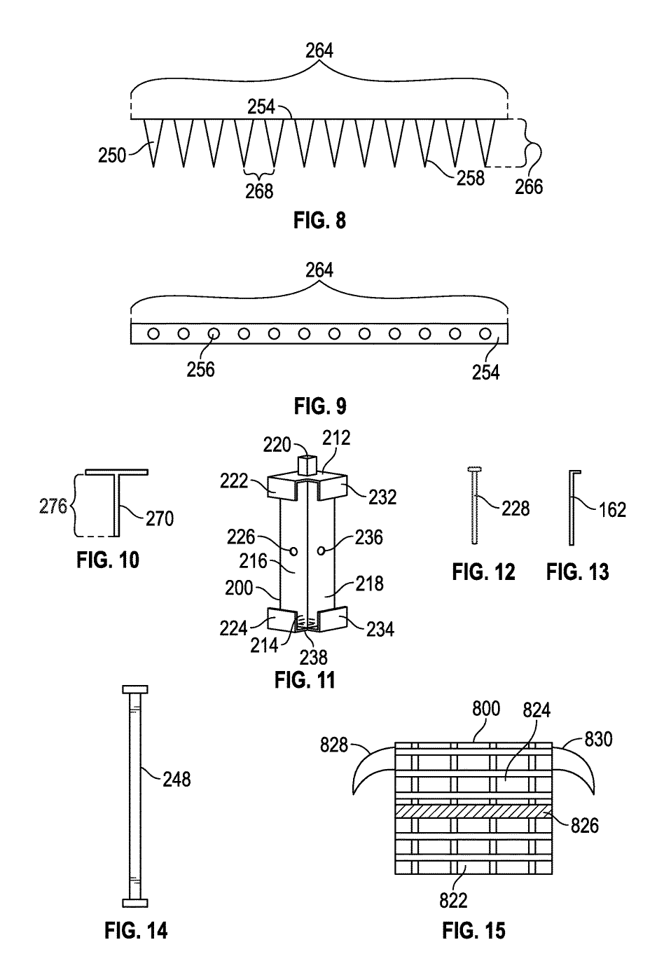

Referring to FIGS. 8, 9, and 10, instead of elongated members 258 formed integrally with the strip 254, one or more elongated members 270 can be inserted into one or more holes 256 formed in the strip 254. The elongated member 270 can have a length or depth 276 of about 0.01:1-about 0.20:1 of the length 264 of the guard 250 to secure the structure 10 and prevent burrowing animals from digging under and into the structure 10 to assault the plant 18. The elongated member 270 can take the form of a stake, prong, cone, spike, nail, or screw, and can extend at least about 2 cm, at least about 2.54 cm or even about 2-about 16 cm.

Referring to FIGS. 1, 2, 3, and 14, a rod or dowel 248 is depicted. The dowel 248 can be inserted through the structure 10 to support, e.g., one or more branches, of the plant 18 as it grows and bears a particularly heavy load, such as fruit. Typically, the dowel 248 is inserted between one or more horizontal portions 42 and vertical portions 44, such as the horizontal portion 42 of the first panel 40 and the horizontal portion 122 of the third panel 120, as depicted in FIG. 3. Although only one dowel 248 is depicted, it should be understood two or more dowels 248 can be used.

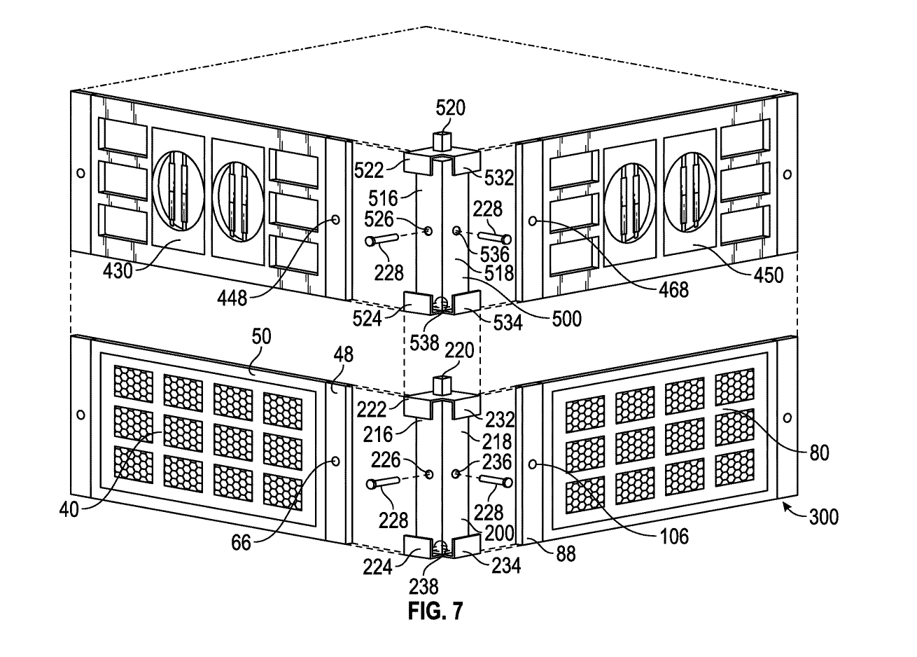

Referring to FIGS. 5 and 7, at the beginning a planting season, the base 300 can be placed on the ground with the plant 18 centered within the cutout 352 of the base 300. Four end supports 200 can be placed in respective openings 342, 344, 346, and 348 and panels 40, 80, 120, and 160 can be positioned adjacent to respective edges 316, 320, 324, and 328 of the base 300. In FIG. 7, a single end support 200 is depicted receiving the first edge 48 of the first panel 40 at the first side 216 of the end support 200 and the first edge 88 of the panel 80 at the second side 218 of the end support 200. Each panel 40 and 80 forms respective holes 66 and 106 that can be aligned with respective holes 226 and 236 of the end support 200. Two securing members 228 can be put through, respectively, the holes 66 and 226 and holes 106 and 236 to the secure panels 40 and 80. Similarly, the opposing edges of the panels 40 and 80 and the panels 120, and 160 may be slid into respective brackets 222 and 224 and 232 and 234 of the end supports and secured with six more securing members 228 as shown in FIG. 12 to form a barrier. Removing the securing member 228 and sliding one or more panels 40, 80, 120, and 160 may allow access to the plant 18. Four guards 250 can be secured to respective undersides of the panels 40, 80, 120, and 160 using any suitable mechanical fasteners, e.g., screws, and driven into the ground to secure the structure 10 and prevent animals burrowing into the structure 10. Optionally, a top frame 280 can be placed onto the first set 20 and secured with any suitable device such as one or more clips.

As the plant 18 grows, a second set 400 can be placed or stacked on the first set 20. The panels 420 of the second set 400 can be substantially similar to or different from the panels 30 of the first set 20. To add height to the structure 10, the top frame 280 can be removed and the four end supports 500 of the second set 400 can be placed on respective four end supports 200 of the first set 20. Generally, the end supports 500 are substantially identical to the end supports 200. In FIG. 7, a single end support 500 with a recess 538 is depicted being placed on the protrusion 220 of the end support 200 to secure the end support 500 to the end support 200. The end support 500 can receive the first panel 430 at the first side 516 of the end support 500 and the second panel 450 at the second side 518 of the end support 500. Each panel 430 and 450 forms respective holes 448 and 468 that can be aligned with respective holes 526 and 536 of the end support 500. Two securing members 228 can put through, respectively, the holes 448 and 526 and holes 468 and 536 to secure the panels 430 and 450. Similarly, the stacked four end supports 500 can have the brackets 522, 524, 532, and 534 and receive opposing sides of the panels 430 and 450 and the panels 470 and 490. Six more securing members 228 can be used to secure the panels 420. The top frame 280 can be clipped to the panels 420 of the second set 400. Similarly, additional end supports can be stacked on the protrusions 520 of respective end supports 500 and panel sets can be added as the plant 18 grows. In this exemplary embodiment as depicted in FIGS. 1-7, the structure 10 can have one base, one top frame, four guards, eight side panels, and eight end supports.

Referring to FIGS. 1-7, another exemplary embodiment can be a sufficiently tough structure for plants. The structure can include a means for stopping burrowing animals, a means for supporting and protecting a growing plant; and a means for accessing the growing plant. The means for stopping burrowing animals may include the base 300, the guard 250, and one or more elongated members 258. The means for supporting and protecting the growing plant can include the first and second sets 20 and 400 of respective plurality of the panels 30 and 420 with sufficient toughness to resist animal assaults. Typically, the means for accessing the growing plant may include the aperture 434 formed in the first panel 430 or removing the first panel 430, or, independently, other panels.

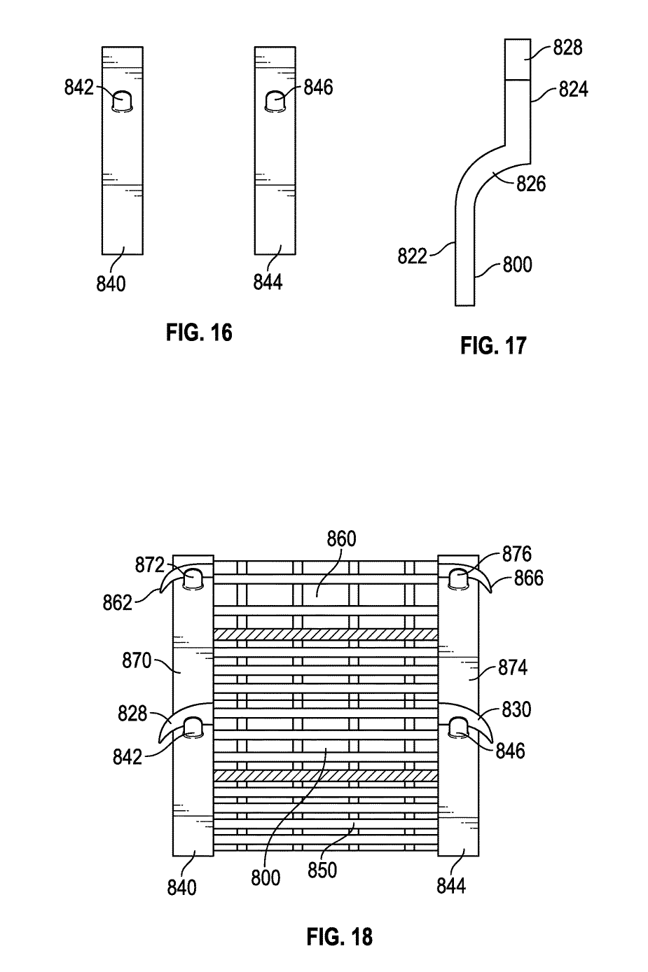

Referring to FIGS. 15-17, another version of a panel is disclosed. A first panel 800 can include a lower, first part 822 and an upper, second part 824. The lower part 822 can be closer to the center of the base 300 than the upper part 824. The upper part 824 is formed integrally with the lower part 822 with a curved portion 826. The parts 822 and 824 can include horizontal and vertical portions forming a grid or lattice structure 850. Also, a first hook 828 and a second hook 830 are formed integrally with the upper part 824. The end supports 840 and 844 can have respective brackets 842 and 846 for receiving respective hooks 828 and 830.

Referring to FIG. 18, another version of a side of a structure 10 can have the first panel 800 and a second panel 860. The hooks 828 and 830 of the first panel 800 engage respective brackets 842 and 846 of respective end supports 840 and 844. The end supports 870 and 874 are stacked on the end supports 840 and 844 and the brackets 872 and 876 receive the hooks 862 and 866 of the second panel 860. The panels 800 and 860 can be raised and removed to allow access to the plant 18 for tending the plant or picking fruit, such as tomatoes.

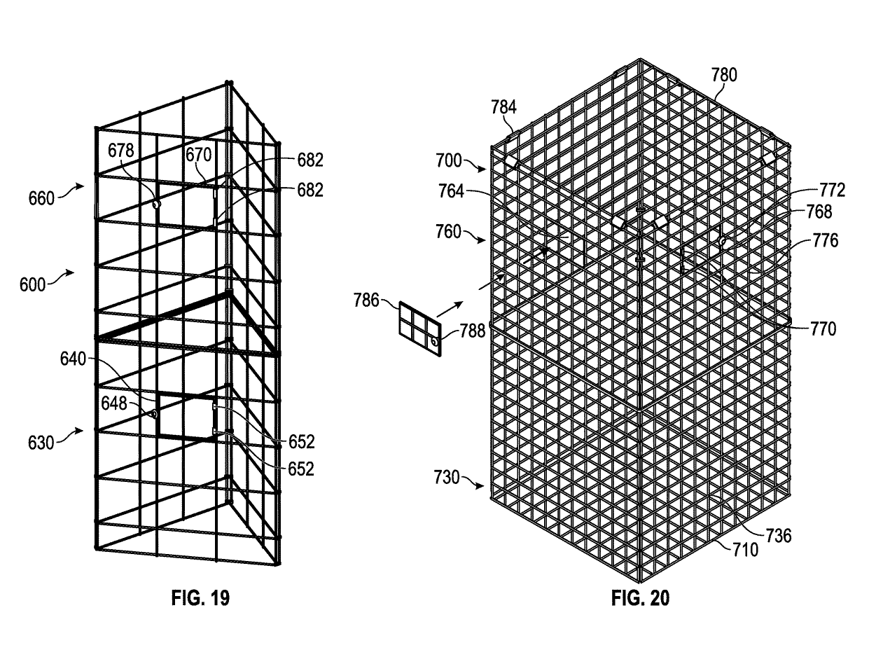

Referring to FIG. 19, another structure 600 can include at least three panels or sides forming a triangular-shaped structure 600. The structure 600 can include a first set or section of panels 630 and a second set or section of panels 660 stacked on the first set 630. In the lower set 630, a door 640 can include a pair of hinges 652 and a knob 648 and in the upper set 660, a door 670 can include a pair of hinges 682 and a knob 678. The door 640 permits access to the lower part of the plant and the door 670 can allow access to the upper part of a plant for pruning, feeding, watering, and picking. Although the doors 640 and 670 are depicted as rectangular, the doors 640 and 670 can be any suitable shape, such as circular or oval. Furthermore, the doors 640 and 670 can be, independently, detachable.

Referring to FIG. 20, yet another structure 700 can include at least four panels or sides forming a rectangular shaped structure having a first set or section of panels 730 and a second set or section of panels 760. Each set 730 and 760 can include four panels. The structure 700 can also include a base 710 and a top frame 780. The first set 730 can be stacked on the base 710, and the second set 760 can be stacked on the first set 730. The top frame 780 can be secured to the second set 760 with any suitable fastener, such as plastic ties or a clip. In this exemplary embodiment, eight clips 784 can secure the top frame 780 to the second set 760. The structure 700 can include horizontal and vertical portions or bars to form a grid or a lattice structure 736 in the first set 730 and a grid or a lattice structure 776 in the second set 760 to protect and support a plant. In the second set 760, a door 768 with hinges 770 and a knob 772 can be provided for accessing a plant for tending to the plant or harvesting fruit. The second set 760 can also form an aperture 764 with a removable door 786 with a knob 788 for accessing the plant. In addition to square and triangular-based geometric figures, other shapes can be used such as rectangular, circular or cylindrical-based geometric figures. Moreover, these structures can be easily and inexpensively manufactured, shipped, and assembled. The geometric structure is constructed close to the plant for supporting its stem and branches.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A plant support system, comprising:
a plurality of panels, comprising a first panel and a second panel wherein the first and second panels comprise respective vertical portions and horizontal portions, and at least one panel forms an aperture optionally covered by a door to allow access to a plant;
an end support coupled to the first panel and to the second panel; and
a removable top frame coupled to the first and second panels.

2. The plant support system according to claim 1, wherein the plurality of panels further comprises a third panel wherein the third panel is positioned substantially parallel to the first panel; and the plant support system further comprises at least one dowel inserted through and supported by a horizontal portion in the first panel and a horizontal portion in the third panel.

3. The plant support system according to claim 1, wherein the plurality of panels comprises at least three panels to form a triangle-based geometric figure.

4. The plant support system according to claim 1, wherein the plurality of panels comprises four panels to form a square-based geometric figure.

5. The plant support system according to claim 1, wherein the plurality of panels comprises a first set, and the plant support system further comprises a second set comprising a second plurality of panels wherein the second set of panels is stacked on top of the first set of panels to add height to the plant support system.

6. The plant support system according to claim 1, wherein the end support further comprises a first bracket and a second bracket for receiving the first or second panel.

7. The plant support system according to claim 6, wherein the first or second panel is removable from the first and second bracket without the use of a tool.

8. The plant support system according to claim 1, further comprising a guard coupled to the end support wherein the guard comprises a plurality of elongated members to impede burrowing animals.

9. The plant support system according to claim 8, wherein the guard further comprises a strip formed with the one or more elongated members positioned downward or the strip forms one or more holes for inserting elongated members downward into the ground to impede burrowing animals.

10. The plant support system according to claim 1, further comprising a base underneath the plurality of panels and forming one or more openings to allow for accurate placement of the end supports.

11. The plant support system according to claim 10, wherein the base further forms a circular cutout of at least about 0.15 meter in diameter for the plant and one or more perforations for allowing the passage of light, air and water to the ground beneath.

12. The plant support system according to claim 11, wherein the base comprises one or more arms and a perimeter, and further comprises a piece forming one or more holes coupled at the perimeter of the base, and allowing the insertion of one or more elongated members downward through the one or more holes into the ground.

13. The plant support system according to claim 10, wherein the end support comprises a bracket and each of the first and second panels has a first part and a second part wherein the first part is closer to a center of the base than the second part.

14. The plant support system according to claim 13, wherein each of the plurality of panels forms a hook at either end of the second part of the panel and is removably coupled to the bracket of the end support.

15. The plant support system according to claim 5, further comprising another end support positioned on an upper end of the end support and a first and a second panel of the second set coupled to the another end support.

16. A structure having sufficient toughness for supporting and protecting a plant, comprising:
a base generally forming a Greek cross forming one or more holes along edges of respective arms, and forming one or more openings between arms;
a plurality of panels forming a first set of panels and comprising a first panel and a second panel wherein the first panel and the second panel are coupled together; and
a top frame coupled to a respective top edge of the first and second panels wherein the plurality of panels provides sufficient toughness to support the plant and protect the plant from animals.

17. The structure according to claim 16, further comprising one or more elongated members inserted through the base to prevent burrowing animals.

18. The structure according to claim 16, wherein a second set of a plurality of panels is positioned on top of the first set of the plurality of panels to add height to the structure.

19. A structure with sufficient toughness for supporting and protecting plants, comprising:
a means for stopping burrowing animals;
a means for supporting and protecting a growing plant; and
a means for accessing the growing plant.

20. The structure according to claim 19, wherein:
the means for stopping burrowing animals comprises a base, a guard, and one or more elongated members;
the means for supporting and protecting the growing plant comprises first and second sets of pluralities of panels having sufficient toughness; and
the means for accessing the growing plant comprises an aperture formed in the panel or a removable panel.
